(19) United States
(12) Patent Application Publication
(10) Pub. No.: US 2012/0318929 A1
(43) Pub. Date: Dec. 20, 2012

(54) AIRCRAFT WITH A REFUELING DEVICE AND METHOD FOR CONTROLLING THE FLIGHT PATH OF AN AIRCRAFT DURING ITS REFUELING

(75) Inventor: Burkhard Gölling, Buchholz i.d.N (DE)

(73) Assignee: AIRBUS OPERATIONS GMBH, Hamburg (DE)

(21) Appl. No.: 13/478,433

(22) Filed: May 23, 2012

Related U.S. Application Data
(60) Provisional application No. 61/488,976, filed on May 23, 2011.

(30) Foreign Application Priority Data
May 23, 2011 (DE) 10 2011 102 279.5

(51) Int. Cl. B64D 39/00; B64C 13/16

(52) U.S. Cl. 244/203

(57) ABSTRACT

An aircraft with a refueling device for receiving fuel from a tanker aircraft in-flight is described, including an arrangement of flow influencing devices, an arrangement of flow condition sensor devices measuring flow conditions on respective surface segments, a flight data transmission device receiving flight data of a tanker aircraft, a flight path specification module that determines a nominal flight path or a nominal flight path corridor from the flight data of the flight data transmission device, and a flight control device configured to generate nominal commands for the flow influencing devices based on the measured flow condition and the nominal flight path or the nominal flight path corridor. These nominal commands control or maintain the movement of the aircraft along the nominal flight path or in the nominal flight path corridor. A method for controlling the flight path of an aircraft during the refueling thereof is also provided.

### CROSS-REFERENCE TO RELATED APPLICATIONS

The present application claims priority from German Application DE 10 2011 102 279.5, filed on May 23, 2011, and claims the benefit of U.S. Provisional application 61/488,976, filed on May 23, 2011, each of which is hereby incorporated in its entirety by reference.

### FIELD OF THE INVENTION

The invention pertains to an aircraft with a refueling device and a method for controlling the flight path of an aircraft during its refueling.

### BACKGROUND

In order to increase the payload capacity, it is known from the prior art to equip an aircraft with a device that allows air refueling by a leading tanker aircraft. Significant problems in air refueling are the continuous weight change of the aircraft being refueled and the tanker aircraft and the requirement to maintain the lift of both aircraft constant during the refueling phase. This is commonly achieved by adapting the lift in combination with a changed adjustment of the angle of attack and, if so required, the flying speed. However, the adaptation of these two parameters is significantly limited for both aircraft in a specified corridor of the flight scenario. In addition, a largely static flight needs to be realized during the refueling process in order to prevent the safety of the participating aircraft from being compromised.

### SUMMARY

Various embodiments of the invention make available measures for an aircraft with a refueling device, as well as a method for controlling the flight path of an aircraft during its refueling, by means of which the aerodynamic efficiency and flexibility of an air-refueled aircraft or the reliability of an aircraft refueling process can be improved.

In accordance with various embodiments of the invention, a high flexibility can be achieved by combining an active flow control on the wing with a conventional regulating flap control. At slow flying speeds and partially extended control flaps or set spoilers, a flow separation or burble can be very flexibly prevented at certain angles of attack of the aircraft. In comparison with an aircraft without flow control, the operative range can be significantly broadened by continuously reapplying the air flow or preventing the separation thereof on the wing and on high-lift devices.

According to various embodiments of the invention, flight data of the tanker aircraft is used by the aircraft being refueled in order to allow a precise control of regulating flaps and of flow influencing devices.

According to some embodiments of the invention, an aircraft with a refueling device for receiving fuel from a tanker aircraft in-flight and with airfoils is proposed, wherein said airfoils are composed of a main wing and at least one control flap that is arranged such that it can be adjusted relative to the main wing, and wherein the aircraft includes:
a flight attitude sensor device for detecting flight attitudes of the aircraft,
an actuator for actuating the at least one control flap,
at least one arrangement of flow influencing devices that are arranged in at least one surface segment of the main wing extending in the wing spread direction and serve for influencing the air flow on the surface segment, and
at least one arrangement of flow condition sensor devices for measuring the flow condition on the respective surface segment,
a flight data transmission device that is designed for receiving flight data, particularly of a tanker aircraft,
a flight path specification module that is functionally connected to the flight data transmission device and determines a nominal flight path or a nominal flight path corridor from the flight data of the flight data transmission device, and
a flight control device that is functionally connected to the flight attitude sensor device, the flight path specification module, the flap position sensor device and the flow condition sensor devices on the input side and functionally connected to the actuator and the flow influencing devices on the output side in order to transmit control commands.

In this case, the flight control device may be realized, in particular, such that it generates nominal commands for the flow influencing devices based on the measured flow condition and the nominal flight path or the nominal flight path corridor and transmits these nominal commands to the flow influencing devices, wherein these nominal commands serve for controlling or maintaining the movement of the aircraft along the nominal flight path or in the nominal flight path corridor.

This function may be realized, in particular, in the form of an operating mode provided for the refueling process of the aircraft such that it can also be referred to as refueling mode. In this case, it would be possible, in particular, that the pilot input device in the form of a specification device for generating nominal commands, by means of which flight attitudes of the aircraft are adjusted, generates input signals for the flight control device upon the selection of this refueling mode and transmits these input signals to the flight control device. In this case, it would furthermore be possible that the flight control device generates nominal commands for the flow influencing devices if the flight path deviates from the nominal flight path or impermissibly approaches the boundaries of the nominal flight path corridor and transmits these nominal commands to the flow influencing devices, wherein these nominal commands serve for controlling the movement of the aircraft along the nominal flight path or maintaining or correcting the movement of the aircraft in the nominal flight path corridor.

The control flap may include, in particular, at least one spoiler or several spoilers or at least one aileron or several ailerons. It would also be possible that the flight control device actuates a control flap that is not arranged on the main wing and may also include the rudder and the elevator of the aircraft in accordance with various embodiments of the invention.

The flight path specification module may be realized, in particular, in the form of a specification device and designed for generating nominal commands that limit the movement of the aircraft along a nominal flight path or in the nominal flight path corridor within predetermined limits relative to the tanker aircraft based on the transmitted flight data of the tanker aircraft.

In this context, the nominal flight path corridor refers to a relative three-dimensional corridor that is derived from positions of the tanker aircraft or the progression of the current flight path of the tanker aircraft or derived from the current flight path and, in particular, from an extrapolated flight path and in which the aircraft being refueled can move relative to the tanker aircraft in order to reliably carry out the refueling process with specific and, in particular, respectively aircraft-external refueling lines. The nominal flight path corridor may be realized in the shape of a cone or truncated cone or alternatively cylindrically or ellipsoidal or a mixture of such shapes. However, the object of various embodiments of the invention is not restricted to a specific shape of the corridor. The thusly designed flight path specification module or specification device therefore is used for realizing a sufficiently accurate flight tracking control for a refueling flight with corresponding nominal commands that depend on the movement of the tanker aircraft.

The aircraft may furthermore include, in particular:
a specification device that is connected to the flight data transmission device on its input side and serves for generating nominal commands corresponding to flight attitudes of the aircraft in the form of input signals for the flight control device, and
a flap position sensor device for detecting the adjusted position of the control flap,

wherein the flight control device is also functionally connected to the specification device and the flap position sensor device on its input side, wherein the flight control device has a function that generates nominal commands for the actuator for actuating the at least one control flap and for the flow influencing devices based on the nominal commands of the specification device, the measured flow condition and the nominal flight path or the nominal flight path corridor and transmits these nominal commands to said actuator and said flow influencing devices such that the movement of the aircraft is controlled along the nominal flight path or maintained in the nominal flight path corridor within predetermined deviations.

The flight control device receiving these nominal commands has, in particular, a function that selects the flow influencing devices to be actuated in dependence on the respectively detected flight attitude and the incoming nominal commands in order to optimize local coefficients of lift on the airfoil. The flight control device may be realized, in particular, in such a way that it generates direct control commands for adjusting the actuator and the flow influencing devices and transmits these control commands to the actuator and the flow influencing devices, wherein the flight control device determines these control commands based on the nominal commands of the specification device, the sensor signals of the flight attitude sensor device and the sensor signals of the flow condition sensor device. The flight control device may, in particular, have a function that selects the flow influencing devices to be actuated in dependence on the flight attitude in order to optimize local coefficients of lift on the airfoil. The flight control device particularly may have a function that is designed in such a way that it selects the flow influencing devices to be actuated in dependence on the respectively detected flight attitude and/or the measured flow condition and/or the incoming nominal commands in order to optimize local coefficients of lift on the airfoil.

In this case, it would be possible, in particular, that the control device determines the nominal flow condition values segmentally in the form of local nominal flow condition values in order to respectively activate an arrangement of flow influences devices in at least one surface segment of each wing or a flap that extends in the wing spread or flap spread direction and to thusly influence the air flow on the surface segment.

According to an embodiment, it is proposed that the flight control device has a prioritizing function that mixes an actuation of flow influencing devices and an actuation of regulating flaps in dependence on deviations of the aircraft from the nominal flight path or positions of the aircraft in the nominal flight path corridor.

According to an embodiment, it is proposed that the flight control device generates commands for actuating the flow influencing devices based on a change of the deviation of the position of the aircraft from the nominal flight path or a change of the positions of the aircraft within the nominal flight path corridor such that the actuation of the flow influencing devices can be preferred in comparison with the actuation of the regulating flaps, particularly at a greater dynamic of the required lift.

According to an embodiment, it is proposed that the flight control device has an estimating function that is designed for estimating whether a flight within predetermined deviations along the nominal flight path or within the nominal flight path corridor lies within the instantaneous flight range limits of the aircraft with the instantaneous mass thereof, namely in dependence on deviations of the aircraft from the nominal flight path and/or in dependence on the positions of the aircraft in the nominal flight path corridor and/or depending on changes of these variables.

According to an embodiment, it is proposed that the flight control device has a warning signal function that generates a warning signal when approaching a flight range limit and/or a predetermined distance from the nominal flight path and/or a predetermined distance from the nominal flight path corridor, wherein the flight control device transmits said warning signal to the flight data transmission device for transmission to the tanker aircraft.

According to an embodiment, it is proposed that the at least one regulating flap includes a spoiler arranged on the airfoil of the aircraft, wherein the arrangement of flow influencing devices and of flow condition sensor devices is situated on a high-lift flap and/or on the main wing.

According to an embodiment, it is proposed that the flight control device has a segmental activating function that is realized such that it generates control commands for the flow influencing device of each segment and/or control commands for the actuator based on the control signals of the flight control device in order to realize an optimization that takes into account the currently available power and/or dynamic of the flow influencing device and/or the actuator of the regulating flap.

The regulating flap that is actuated by the actuator activated by the flight control device may include, in particular, a control flap, especially at least one spoiler or a spoiler flap of the aircraft. The regulating flap may alternatively or additionally also include an adjusting flap. In this context, the term adjusting flap refers to a regulating flap of a secondary flight control that essentially does not adjust an operating state or a flight attitude dynamically and is not or not primarily used for controlling the aircraft. The adjusting motion of the control flap therefore is carried out continuously during the control of the aircraft while the adjusting flap is not adjusted during a flight phase are part of the flight phase such as, e.g., the take-off or the landing. The adjusting flap may include, in particular, a high-lift flap such as a leading edge flap or a trailing edge flap. According to various embodiments of the invention, the regulating flap activated by the flight control device may also include a flap that fulfills the function of an adjusting flap, as well as the function of a control flap.

The flight control device may be realized, in particular, in such a way that it not only generates control commands for adjusting the actuator of the regulating flap, but also control commands for activating and actuating the flow influencing devices and transmits these control commands to the flow influencing devices. The activation of the flow influencing devices therefore is functionally integrated into the generation of control commands for adjusting the actuator of the at least one regulating flap or control flap, and the correspondingly generated activation commands for actuating the flow influencing devices and the actuator of the at least one regulating flap or control flap are functionally interdependent. In this case, the flight control device determines the current control commands for activating the actuator and the flow influencing devices based on the nominal commands of the specification device, the sensor signals of the flight attitude sensor device and the sensor signals of the flow condition sensor device.

The specification device may include, in particular, a control specification device for the actuation of regulating flaps and, in particular, control flaps for controlling the aircraft and/or for the adjustment of adjusting flaps in accordance with various embodiments of the invention. The function of the specification device primarily includes specifying a flight path that is defined relative to the tanker aircraft in the form of a corridor similar to a pilot in a modern fly-by-wire aircraft, wherein the three-dimensional reference point of said corridor is transmitted from the tanker aircraft to the aircraft being refueled as part of its flight data. The nominal data specified by the specification device may include, for example, rates of ascent or descent or accelerations.

The secondary control tasks for realizing and stabilizing the instantaneous flight attitude required for observing the specified flight path are carried out by the flight control device. During refueling, the functions of the flight control device may, for example, include an adaptation of the lift of the aircraft being refueled to its mass that continuously increases during the refueling process by adjusting regulating flaps and by occasionally increasing the thrust as required, wherein a possibly continuous shift of the center of gravity is simultaneously compensated. According to various embodiments of the invention, the flight control device additionally optimizes local coefficients of lift by influencing the flow on the surface of the airfoil and/or the regulating flap in dependence on the flight attitude and the control commands by specifying a selection of flow influencing devices to be actuated.

The flight data transmitted from the tanker aircraft to the aircraft being refueled advantageously includes, in particular, the position, the instantaneous speed and the instantaneous acceleration of the tanker aircraft. This data originates from sensor systems of the tanker aircraft such as the ADIRU, particularly an Air Data Reference Unit (ADR) that can provide information on the speed, the altitude, the temperature of the outside air and the angle of attack and, in particular, an Inertial Reference Data System that can provide information on the altitude, vertical speed and flight path of the tanker aircraft. In comparison with the prior art, the tanker aircraft can observe much more dynamic flight paths, which the aircraft being refueled follows within the defined corridor, due to the combination of an automatic tracking control and the selective actuation of flow influencing devices.

In this case, the flight control device may include, in particular, a control algorithm that adjusts the aforementioned input values in accordance with the received nominal commands (“complete control”). The control algorithm of the flight control device may be composed on the one hand of a synthesis of a quantity for the lift, the drag or the lift/drag ratio obtained from sensor data, particularly from respective sensor devices that are locally assigned to flow influencing devices on the airfoil or the flap, and on the other hand of a robust control algorithm for reaching a specified target value for the aforementioned quantity. The controller is preferably supported by an Anti-Wind-Up-Reset-Structure.

The selection of the flow influencing devices to be respectively activated and the determination of the intensity, with which the flow influencing devices are activated at a given time, can be realized, in particular, based on a combination of time integration and look-up table and bijectively linked with a flight-relevant variable such as, e.g., a parameter for the local lift that is respectively assigned to the flow influencing devices. In this case, a parameter for the local lift can be respectively determined, in particular, over a segment of the flow surface of the airfoil or the regulating flap, in which a plurality of flow influencing devices are arranged. In this way, an indirect specification, e.g., of a lift or a coefficient of lift that is subsequently converted into a specification of the quantity by means of an algorithm can be realized in order to actuate the flow influencing devices. It would furthermore be possible to use the parameter for the local lift for determining the deviation of the respective parameter for the local lift from a current quantity measured by means of respectively assigned sensor devices, wherein this deviation is then used for determining if and with what intensity the respective flow influencing device is activated.

The controller may be designed on the basis of a linear Multivariable-Black-Box-Model with a method for the synthesis of robust controllers. During the identification of the linear Multivariable-Black-Box-Model, suitable interference signals in the form of erratic changes of the actuation variable are generated and the reaction of the quantity to these changes is measured. A linear differential equation system that represents the basis for the controller synthesis is obtained from the dynamic behavior of the reaction with the aid of parameter identification methods. Many different identifications of this type deliver a model family, from which a representative or average model is selected per synthesis. Certain methods can be used in the controller synthesis (e.g., Hoc-Synthesis, robustification, robust LoopShaping). The created classic linear control loop can be supported by an Anti-Wind-Up-Reset-Structure that, if a correcting variable that lies above the realizable correcting variable is requested, corrects the internal conditions of the controller in such a way that an integration section in the controller does not lead to overshooting or freezing of the controller. In this way, the controller also remains responsive when it receives unrealistic requests such that the operational reliability is increased. It is always adapted to the current situation and not delayed by preceding correcting variable limits.

The controller may be realized, in particular, in the form of an optimal controller that receives all required input variables in the form of controlled variables and generates the different output signals for the flow influencing device and/or the actuator or flap drive of the at least one activated regulating flap in accordance with a control algorithm in a matrix-like method-based on calibrations and parameters for the assignment of controlled variables and correcting variables derived thereof in dependence on flight attitude variables.

According to an example embodiment of the invention, the controller is functionally realized in such a way that it generates a control signal vector containing control signals for the at least one actuator of the regulating flap and, in particular, the at least one control flap on the one hand and control signals for flow influencing devices on the other hand with an integrated controller function and, in particular, in an operational interval or iteration step. It is also specified in the control signals for flow influencing devices whether control signals for a few or all flow influencing devices even need to be generated, i.e., which flow influencing devices are respectively activated.

According to an example embodiment of the invention, the flight control device may be realized in such a way that it generates a current control signal vector with correcting variables for adjusting the actuator of the at least one control flap and the flow influencing devices by means of a controller model for the aircraft and transmits this control signal vector to the actuator and the flow influencing devices, wherein the flight control device determines the current input signal vector based on the nominal commands of the specification device, the sensor signals of the flight attitude sensor device and the sensor signals of the flow condition sensor device.

Various embodiments the invention take into account, in particular, systemic limitations with respect to the maximum displaceability of the trailing edge device with consideration of loads, maintenance requirements and costs and simultaneously improves the aerodynamic performance of a high-lift system. On a more significantly curved profile, the separation of the flow is furthermore prevented on the upper side of the adjusting flap. In addition, various embodiments of the invention fulfill the very strict requirements for the adjustment of an adjusting flap relative to the main wing with respect to the weight and an efficient overall system integration such that a complete high-lift system can be optimized with respect to its weight and cost.

According to various embodiments of the invention, particularly the adjusting flap therefore may include a high-lift flap arranged on the airfoil of the aircraft, wherein the arrangement of flow influencing devices and of flow condition sensor devices is positioned on the high-lift flap and/or on the main wing.

The respective flight-relevant parameter provided for the flow influencing devices may also correspond, e.g., to a local coefficient of lift, a local drag or a local lift/drag ratio and be determined in an instationary fashion from substitute controlled variables in order to subsequently use this parameter for a nominal value comparison and to ultimately adjust a basically arbitrary value for the respective parameter—within the scope of physics—from which control signals for the local flow influencing devices can be determined by means of linear, robust control algorithms designed for a linear model.

Since no heavy moving parts are used, the control system is significantly faster than conventional mechanical solutions such that local flow phenomena can be purposefully suppressed or utilized, respectively.

In this case, the function for determining the selection of flow influencing devices to be activated may be a filter function or based on a filter function. In this case, it would be possible, in particular, that the flow influencing devices, the respectively assigned sensor devices of which deliver measuring signals that lie within a permissible range, are not activated, i.e., assigned control signals with the value zero. The local flow speed or the local pressure may, in particular, exceed a minimum value in this case. In contrast, control signals with an activation value are determined for flow influencing devices, the respectively assigned sensor devices of which deliver measuring signals that lie outside a permissible range, wherein this permissible range may be defined, in particular, such that its limit forms the transition to local flow separations.

These individual flow control measures are by themselves suitable measures for preventing the separation on the flap partially or completely for a certain area. However, they merely represent individual subsystemic solutions because they are only designed for a specific configuration.

Due to an excitation system that is cascaded in the chord direction and controlled in a segmented fashion, different flow situations that are prone to separations and caused by different configurations can be prevented more efficiently. A periodic or pulsed blow-out of compressed air through slots or similar types of topologies on the trailing edge flap already proved highly effective and was also much more efficient (by a factor of 2 to 4) than a continuous blow-out for the investigated configurations with respect to the air mass flow used. Since the flow conditions in the region of the flap vary with changing flap positions, different separation conditions with different separation positions may also be adjusted on the trailing edge flap.

However, an actuator system with a defined excitation position is only optimized for a certain range such that the efficiency of the active flow control decreases in an Off-Design scenario and the energy requirement may increase excessively.

The periodic or pulsed blow-out through slots or similar types of topologies on the trailing edge flap with slots that are arranged in a segmented and cascade-like fashion or similar types of topologies therefore may prove particularly efficient because the respective flow conditions can be better controlled and the energy input into the separated or separating flap flow in the form of the pulsed nozzle flow takes place purposefully and in an efficiently distributed fashion. If a control of the coefficient of lift as exemplary target variable is furthermore utilized, the effect can be controlled autonomously and realized efficiently.

Initial experimental results on two-dimensional profiles showed that a cascade-like arrangement of the excitation system makes it possible to efficiently reapply a flow prone to separation. The investigations on industrial wind tunnel models have already verified the effectiveness of this flow control technique on the basis of model actuators.

A required number of suitable sensors such as, for example, pressure sensors are integrated into the trailing edge flap in the chord direction and the wing spread direction in order to detect the current local flow condition. The thusly obtained measuring data and the target value specification of a certain parameter such as, for example, the coefficient of lift or the rate of ascent and/or descent by the pilot serve as input values for a correspondingly designed control loop. The parameters frequency, pulse width, pulse input into the flow and/or phase shift between the excitation positions can be used as correcting variables for the actuator system. The excitation positions may be operated separately or jointly depending on the current flow scenario. Segmented, pulsed compressed air actuators are particularly suitable as excitation mechanism because they have already proven themselves in numerous experiments. However, other actuators such as, for example, synthetic jet actuators or mechanically, electrically and/or pneumatically operated actuators may, in principle, also be used for the presently described application if they have a corresponding functionality and power and also fulfill the requirements with respect to the integration into a control loop for realizing a dynamic control/adjustment.

According to further embodiments of the invention, the flight control device may include a flight attitude control device and a flow condition control device, wherein:
the flight attitude control device is configured in such a way that it generates control commands for the actuator of the control flap and nominal flow condition values for the flow influencing devices based on the nominal commands of the specification device, the sensor signals of the flight attitude sensor device and based on sensor signals of the flow condition sensor device, and
the flow condition control device is functionally connected to the flight attitude control device in order to receive the nominal flow condition values for adjusting the flow influencing devices and configured in such a way that the flow condition control device transmits flow condition control commands to the flow influencing devices based on the nominal flow condition values and based on the sensor signals of the flow condition sensor device of the flow influencing devices.

The nominal flow condition values may include, in particular, the local coefficients of lift or the ratios between the coefficient of drag and the coefficient of lift in the corresponding segment.

The flight control device may also have an activating function that receives the control commands for the actuator of the control flap and the flow condition control commands for the flow influencing devices in the form of input signals, adapts said control signals to one another based on a correlation function, generates control commands for actuating the actuator of the control flap and for the flow influencing devices and transmits these control commands to the actuator and the flow influencing devices. In this case, the activating function may be configured in such a way that the control commands for the flow influencing device and the control commands for the actuator of the control flap are optimized with consideration of the currently available power and/or dynamic of the flow influencing device and/or the actuator of the control flap.

According to various embodiments of the invention, the flow influencing device of a main wing or the adjusting flap may be composed of a pressure chamber that is arranged in the main wing and/or the adjusting flap and serves for accommodating compressed air, an outlet chamber with outlet openings, one or more connecting lines for connecting the pressure chamber to the outlet chamber and at least one valve unit that is integrated into the connecting line and functionally connected to the flight control device, wherein the flight control device activates the valve unit by means of the current control signal vector in order to prevent the compressed air situated in the pressure chamber from flowing through the outlet openings or to enable this compressed air to flow through the outlet openings with a corresponding speed and/or throughput in accordance with the control values of the current control signal vector and to thusly influence the flow around the surface of the main wing or the adjusting flap.

According to various embodiments of the invention, the specification device may include a control input device, the actuation of which causes the nominal commands to be generated, or an autopilot device that generates the nominal commands, e.g., for controlling the flight path of the aircraft along a predetermined nominal path, based on a predetermined operating mode.

According to an embodiment of the invention, the flight control device may be configured in such a way that it generates nominal commands for the flow influencing devices based on the measured flow condition and/or control inputs generated by a specification device and/or the nominal flight path and/or the nominal flight path corridor and transmits these nominal commands to the flow influencing devices, wherein these nominal commands serve for controlling or maintaining the movement of the aircraft along the nominal flight path or in the nominal flight path corridor.

In this case, the aircraft according to an embodiment of the invention may be designed such that the flight control device is configured in the form of a flight attitude control device or features such a flight attitude control device, as well as a flow condition control device. The flight attitude control device is configured in such a way that it transmits input signals to the flow condition control device that is functionally connected to the flight control device based on the nominal commands of the specification device and the sensor signals of the flight attitude sensor device. In addition, the flow condition control device may in this case be configured in such a way that it generates flow condition control commands for activating the flow influencing device of each segment based on the input signals of the flight attitude control device and based on the sensor signals of the flow condition sensor device of each segment and transmits these flow condition control commands to the flow influencing device of each segment in order to control the aircraft in accordance with the nominal commands of the specification device.

In this case, the flight attitude control device may include a segment activating function that is configured in such a way that it generates control commands for the flow influencing device of each segment and/or control commands for the actuator based on the control signals of the flight attitude control device by means of an optimization that takes into account the currently available power and/or dynamic of the flow influencing device and/or the actuator of the regulating flap.

According to various embodiments of the invention, the arrangement of flow influencing devices may be composed of blow-out openings that are arranged in a segment or several segments, as well as a flow generating device that is arranged in the wing and serves for blowing out and/or sucking in air, wherein fluid is blown out of or sucked into the blow-out openings by means of said flow generating device in order to influence the locally occurring coefficient of lift on the segment.

In this case, the arrangement of flow influencing devices may additionally include suction openings that are arranged in a segment or several segments, as well as a suction device that is arranged in the wing and fluidically connected to the suction openings, wherein fluid is sucked into the suction openings by said suction device in order to influence the locally occurring coefficient of lift on the segment.

The flow control may be realized by blowing out compressed air over the wing spread in a pulsed fashion at a defined chord position of the adjusting flap or the trailing edge flap. The valve unit or switching unit provided in accordance with an embodiment of the invention may be operated with variable frequency, variable duty cycle (ratio between the open time with air flowing through the valve unit and the period of a cycle) and air mass flow such that a (periodically) pulsed air flow with variable pulse is generated. The desired outlet speed distribution at the excitation point can be realized with the aid of a pressure chamber or actuator chamber.

Due to the load and safety requirements for the take-off and landing phases to be fulfilled for reasons of weight limits, the technical boundaries for the design of such a trailing edge flap without and with lowered spoiler and an adjusted or extended trailing edge flap are significantly broadened.

According to various embodiments of the invention, the at least one segment may be composed of several segments that are successively arranged in the wing spread direction of the wing.

In some embodiments of the invention, the flight control device has a prioritizing function that mixes an actuation of flow influencing devices and an actuation of regulating flaps in dependence on the flight data of the tanker aircraft. Since the actuation of regulating flaps should, depending on the design of the flow influencing devices, be carried out less dynamically than the actuation of flow influencing devices, the prioritizing function could prefer the corresponding actuation of flow influencing devices in dependence on the derivation of the required lift, for example for more dynamic lift requirements, while a preferred actuation of regulating flaps would be sensible for less dynamic changes of the required lift.

In some embodiments of the invention, the flight control device has an estimating function that is designed for estimating whether a flight in the predetermined corridor relative to the tanker aircraft lies within the instantaneous flight range limits of the aircraft with the instantaneous mass thereof, namely based on the flight data being received from the tanker aircraft. The flight range limits are also referred to as “Flight Envelope” and defined by an aerodynamic limit, a performance limit, a temperature limit and a stability limit. The aerodynamic limit is defined by the slowest attainable flying speed, at which a maximum lift corresponds to the weight of the aircraft with the instantaneously accommodated fuel quantity. The performance limit in a level flight is defined by an equilibrium between the maximum attainable trust and the drag occurring at this thrust. The temperature limit is only relevant for high-power supersonic aircraft and not important for a refueling flight. The stability limit is specified in the form of a maximum flight Mach number, at which the occurring forces and moments in a level flight reach the limits of the structural design with consideration of conventional safety factors.

The estimating function is designed for determining whether the aircraft with the increasing fuel quantity accommodated therein approaches the aerodynamic flight range limit by continuously calculating the slowest required flying speed and comparing the calculated flying speed with the current flying speed. The calculation of the slowest required flying speed includes the maximum attainable lift at the maximum coefficient of lift possible by actuating the regulating flaps and the flow influencing devices at the maximum angle of attack possible. The estimating function should furthermore have a mass estimating subfunction that estimates or determines the instantaneous mass of the aircraft during the refueling process, e.g., from a calculation of a starting mass, a fuel consumption and a time integral of a volumetric fuel flow through a fuel delivery probe of the tanker aircraft multiplied by a usually temperature-dependent density. This is followed by a calculation of the required lifting force and therefore a coefficient of lift at the instantaneous flying speed and the instantaneous flight altitude. The risk of reaching the aerodynamic flight range limit increases when the required coefficient of lift approaches the maximum coefficient of lift.

The flight control device preferably has a warning signal function that generates a warning signal when approaching a flight range limit that includes at least the aerodynamic flight range limit and a maneuvering limit, wherein said warning signal is transmitted to the tanker aircraft by the flight data transmission device. In this case, a maneuvering limit may be a flight attitude that refers to an acceleration in the direction of any axis of the fixed aircraft coordinate system.

The warning signal may be configured, for example, in the form of a data set, data block or data telegram that contains more detailed information on the type of warning, e.g., the excessively slow flying speed. Due to this measure, it can be immediately noticed in the tanker aircraft that the aircraft being refueled—e.g., when approaching the aerodynamic flight range limit—requires, for example, a faster flying speed in order to avoid a crash and to safely continue the refueling process. This can be used by a control intervention device in the tanker aircraft in order to automatically increase the speed of the tanker aircraft or the like.

The flight data transmission device is furthermore preferably configured in the form of a wireless flight data transmission device that is based, e.g., on WLAN or similar digital data transmission standards with transmission frequencies in the single-digit or lower double-digit gigahertz range or lower.

According to further embodiments of the invention, a method for controlling the flight path of an aircraft during the refueling thereof by means of a refueling device for receiving fuel from a tanker aircraft in-flight is proposed, wherein said method includes:
detecting flight attitudes of the aircraft,
receiving flight data of the tanker aircraft via a flight data transmission device,
determining a nominal flight path or a nominal flight path corridor from the flight data of the flight data transmission device,
measuring the flow condition on at least one surface segment of the main wing, and
generating nominal commands for flow influencing devices of the main wing and/or the high-lift flap based on the measured flow condition and the nominal flight path or the nominal flight path corridor and transmitting these nominal commands to the flow influencing devices, wherein the nominal commands are defined in such a way that they control or maintain the movement of the aircraft along the nominal flight path or in the nominal flight path corridor.

In the method for controlling the flight path of an aircraft during refueling, the activation of a refueling mode may cause the control input device to be switched into the inactive state.

In the method for controlling the flight path of an aircraft during refueling, the activation of a refueling mode may alternatively or additionally cause the control input device to be switched into the active state such that an input by means of the control input device is possible during refueling of the aircraft and the actuation of the control input device by the pilot causes nominal commands for the actuator for actuating the at least one control flap to be generated in order to control or maintain the movement of the aircraft along the nominal flight path or in the nominal flight path corridor within predetermined deviations, wherein the flight control device has a function, by means of which deviations of the aircraft from the nominal flight path or approaches of boundaries of the nominal flight path corridor are at least partially compensated.

According to various embodiments of the invention, flight data of the tanker aircraft may be transmitted from the tanker aircraft to the aircraft being refueled and the flight data of the tanker aircraft may be functionally taken into account in the determination of the nominal flight path or the nominal flight path corridor in order to in turn take into account the current nominal flight path or the current nominal flight path corridor in the movement of the tanker aircraft relative to the aircraft being refueled.

According to the method for controlling the flight path of an aircraft during refueling, the generated nominal flight path and/or the nominal flight path corridor generated thereby and, in particular, its boundary lines or boundary surfaces may be displayed on a pilot display together with the position of the aircraft relative to the nominal flight path or the nominal flight path corridor, respectively.

According to the method for controlling the flight path of an aircraft during refueling, the nominal flight path or the nominal flight path corridor may be repeatedly calculated anew within predetermined time intervals depending on the flight path and the position and the instantaneous flight attitude of the tanker aircraft and displayed to the pilot in updated form within certain time intervals, wherein the display device displays a Flight Director with an indication of the nominal movement of the aircraft to be currently adjusted relative to the actual flight attitude of the aircraft, as well as the current position of the aircraft being refueled relative to the tanker aircraft from the view of the aircraft being refueled.

According to further embodiments of the invention, a computer program product is proposed that causes the method for controlling the flight path of an aircraft during refueling to be carried out on a program-controlled device.

According to further embodiments of the invention, a refueling system with a tanker aircraft with a refueling device and an aircraft being refueled is proposed. According to various embodiments of the invention, the tanker aircraft includes a control unit that is designed for transmitting the flight data of the tanker aircraft to the aircraft being refueled via the above-described data link. For this purpose, the control unit may be connected to a flight management system, a flight control device or other devices of the tanker aircraft that are familiar with the instantaneous flight data, e.g., from the ADIRU.

In some embodiments of the refueling system and the aircraft, the flight control device of the aircraft is designed for transmitting the instantaneous flight data to the tanker aircraft via the data link. The control unit of the tanker aircraft therefore can compare the instantaneous flight path of the aircraft being refueled with the corridor defined by the tanker aircraft and generate a warning signal when the aircraft being refueled leaves the corridor in order to thusly alert, for example, a pilot of the tanker aircraft of a possible problem.

The tanker aircraft preferably includes a control intervention device that is functionally connected to the control unit and designed for initiating an adaptation of flight parameters of the tanker aircraft when a warning signal from the aircraft being refueled is received. This could include, for example, an increase in the flying speed of the tanker aircraft as the weight of the aircraft being refueled increases such that a sufficient separation from the aerodynamic flight range limit of the aircraft being refueled is achieved.

### BRIEF DESCRIPTION OF THE DRAWINGS

The invention is described below with reference to the attached figures, in which:

FIG. 1 shows a perspective representation of an aircraft, into which the flow influencing device is integrated;

FIG. 2 shows a schematic representation of the cross section of an airfoil with an arrangement of flow influencing devices and flow condition sensors provided in at least one segment thereof, as well as an optionally provided regulating flap that can be adjusted by an adjusting device with an actuator;

FIG. 3 shows an example embodiment of a flight control with a flight control device that is functionally connected in an example fashion to an actuator of a control flap and to two flow influencing devices that respectively form part of an arrangement of a flow influencing device and a flow condition sensor device that is distributed over a surface segment, wherein the flow condition sensor device of each segment is functionally connected to the flight control device, and wherein one respective arrangement of a flow influencing device and a flow condition sensor device that is distributed over a surface segment is positioned on the upper side of the main wing and the upper side of an adjusting flap;

FIG. 4 shows a sectional representation of an example embodiment of the flow influencing device that is installed, for example, in an adjusting flap;

FIG. 5 shows a schematic perspective representation of the flow influencing device illustrated in FIG. 4;

FIG. 6 shows a schematic representation of an airfoil with a main wing and an adjusting flap in the form of a high-lift flap that is coupled thereto and on the upper side of which an arrangement of blow-out openings of a flow influencing device is positioned;

FIG. 7 shows a top view of a surface segment of an adjusting flap with an example arrangement of flow influencing devices and flow condition sensor devices; and

FIG. 8 shows a schematic representation of a refueling system.

Identical or similar components and functions may be identified by the same reference symbol in the figures.

### DESCRIPTION

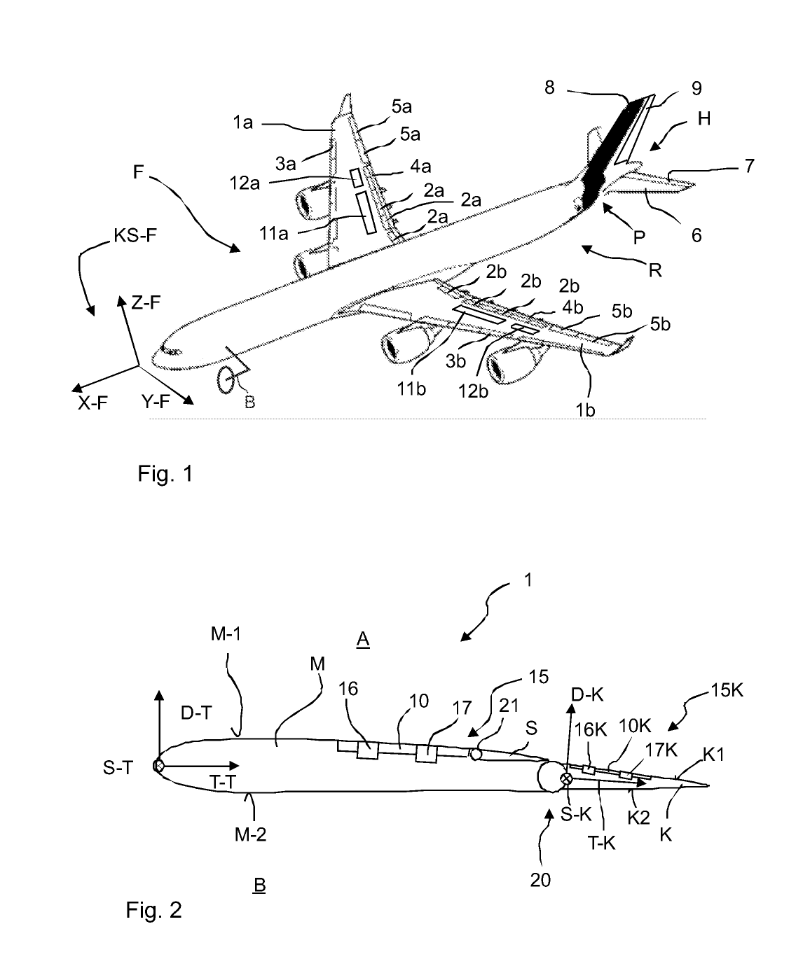

The example embodiment of a controlled aircraft F that is illustrated in FIG. 1 and in which various embodiments of the invention can be utilized has a conventional shape with two airfoils 1a, 1b that respectively include at least one aileron 5a and 5b. The aircraft illustrated in FIG. 1 furthermore includes three respective leading edge lift bodies 3a, 3b and three trailing edge lift bodies 4a, 4b in the form of high-lift flaps on each airfoil 1a, 1b. The airfoils 1a, 1b optionally may respectively include a plurality of spoilers 2a, 2b. The aircraft F furthermore includes a tail assembly H featuring a rudder unit 8 with a rudder 9 and an elevator unit 6 with at least one respective elevator 7. The elevator unit 6 may be configured, e.g., in the form of a T-shaped tail unit as illustrated in FIG. 1 or a cruciform tail unit. In addition, the aircraft F includes a refueling device B that can be docked to a fuel delivery device of a tanker aircraft for air refueling.

In FIG. 1, a coordinate system KS-F referred to the aircraft F is plotted with a longitudinal aircraft axis X-F, a lateral aircraft axis Y-F and a vertical aircraft axis Z-F. An airfoil coordinate system KS-T with an axis S-T for the wing spread direction, an axis T-T for the chord direction and an axis D-T for the thickness direction of the airfoil may be assigned to each airfoil 1a, 1b (FIG. 2). Furthermore, a flap coordinate system KS-K with an axis S-K for the wing spread direction of the flap, an axis T-K for the chord direction and an axis D-K for the thickness direction of the flap may be assigned to each flap (FIG. 2).

FIG. 2 schematically shows an airfoil 1 that is composed of a main wing M and a control flap S provided for controlling or maneuvering the aircraft, as well as a high-lift flap K. The control flap S is illustrated in the form of a spoiler in FIG. 2 and could, in functional respects according to various embodiments of the invention, alternatively or additionally include, e.g., an aileron or even an elevator 7 and/or a rudder 9—even if it is not arranged on the main wing.

FIG. 2 shows a detailed illustration of a main wing 10 with a regulating flap K that is coupled to the main wing M. According to various embodiments of the invention, the aerodynamic body may include the regulating flap K, i.e., an aerodynamic body that is adjustably arranged on the aircraft such as, e.g., a regulating flap of the type illustrated in FIG. 1, namely a high-lift flap, an aileron, a spoiler, an elevator or a rudder. The aerodynamic body may, in particular, also include a main wing M. The main wing M has an upper side M-1 extending on the suction side A thereof, an underside M-2 extending on the pressure side B thereof and, if applicable, a rear side facing the high-lift flap K. A flap chord direction T-K or generally chord direction, a wing spread direction S-K or generally wing spread direction and a flap thickness direction D-K or generally flap thickness direction are defined for the high-lift flap or generally for the regulating flap K or the aerodynamic body. The regulating flap K or high-lift flap has an upper side K1 extending on the suction side A of the high-lift flap K and an underside K2 extending on the pressure side B of the high-lift flap K.

In order to further elucidate various embodiments of the invention, we refer to the combination of a main wing, at least one spoiler in the form of a control flap S and a high-lift flap in the form of an adjusting flap that is schematically illustrated in FIG. 2. In this application, in particular, the at least one control flap S may additionally include an aileron and/or the elevator and/or the rudder. Alternatively or additionally to the high-lift flap, the horizontal stabilizer and/or the rudder unit and generally also an adjusting flap and generally a regulating flap of the aircraft according to various embodiments of the invention may be functionally incorporated as adjusting flap.

According to an embodiment of the invention, a flight control device 50 is provided that is functionally connected to the flight attitude sensor device 40 and to the flight path specification module BF on the input side and functionally connected to the flow influencing devices 16, 16K on the output side in order to transmit control commands. The flight path specification module BF delivers a nominal flight path determined from the flight data of the flight data transmission device D or a nominal flight path corridor determined from the flight data of the flight data transmission device D to the flight control device 50. The flight control device 50 is configured in such a way that it generates nominal commands for the flow influencing devices 16, 16K based on the position of the aircraft relative to the nominal flight path or relative to the nominal flight path corridor and transmits the nominal commands to these flow influencing devices, wherein the movement of the aircraft is controlled or maintained along the nominal flight path or in the nominal flight path corridor with said nominal commands. In this case, the aircraft may be controlled, in particular, by the pilot in order to prepare for the refueling process and/or to carry out the refueling process such that corrections required by changed flow conditions, e.g. due to flying movements or changes of position of the tanker aircraft or due to deviations of the control movements adjusted by the pilot, are carried out with the flow influencing devices 16, 16K. In this case, the aircraft generally may include flow influencing devices 16 on the main wing and/or flow influencing devices 16K on the high-lift flap K such that, if flow influencing devices 16 are present on the main wing, the flight control device 50 generates control commands for the flow influencing devices 16 on the main wing and transmits the control commands to these flow influencing devices. If flow influencing devices 16K are present on the high-lift flap K, the flight control device 50 accordingly generates control commands for the flow influences devices 16K on the high-lift flap K and transmits the control commands to these flow influencing devices.

According to various embodiments of the invention, a flight control device 50 is provided that is functionally connected to the flight attitude sensor device 40, the flight path specification module BF, optionally to the flap position sensor device and optionally to the flow condition sensor devices 17, 17K on the input side and functionally connected to the actuator 20 and the flow influencing devices 16, 16K on the output side in order to transmit control commands.

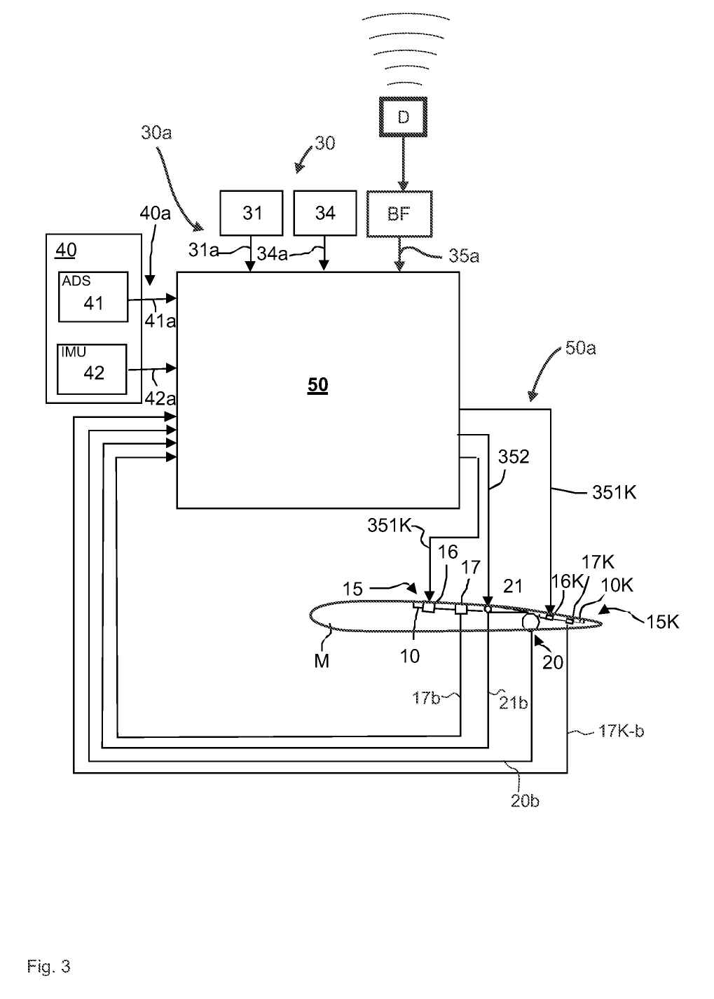

According to various embodiments of the invention, a flight control device 50 is provided that is configured, in particular, in such a way that it generates nominal commands for the flow influencing devices 16, 16K based on the measured flow condition and the nominal flight path or the nominal flight path corridor and transmits the nominal commands to these flow influencing devices, wherein the movement of the aircraft is controlled or maintained along the nominal flight path or in the nominal flight path corridor with said nominal commands. The flight control device 50 may also be configured in such a way that it generates control commands for adjusting the respective actuator 21 of a control flap S and/or the respective actuator 20 of an adjusting flap K such as the high-lift flap and for flow influencing devices 15; 15K arranged on the airfoil 1a, 1b, 1 and/or on at least one adjusting flap and transmits the control commands to said actuator(s) and flow influencing devices (FIG. 3), wherein the movement of the aircraft is respectively or collectively controlled or maintained along the nominal flight path or in the nominal flight path corridor with these control commands. The flight control device 50 determines the current control commands 50a based on nominal commands 30a of a specification device 30 and/or a flight path specification module BF that is connected to a flight data transmission device D capable of receiving and transmitting flight data from/to a tanker aircraft that is not illustrated in the figures.

The flight control device 50 is configured in such a way that it incorporates sensor signals 40a of a flight attitude sensor device 40 and sensor signals of a flow condition sensor device 17; 17K, as well as a nominal flight path or a nominal flight path corridor, if applicable with an auxiliary line, that is generated from the flight data received from the flight data transmission device D by the flight path specification module BF, into the generation of nominal commands. The nominal commands are generated in such a way that the aircraft F remains behind the tanker aircraft in a corridor that is not shown in this illustration or controlled along a nominal flight path that has a predetermined relative position to and distance from the current and/or a calculated path or movement of the tanker aircraft while the tanker aircraft delivers fuel to the aircraft F. On the input side of the flight control device 50, in particular, a specification device may be provided that is connected to the flight data transmission device and serves for generating nominal commands that correspond to flight attitudes of the aircraft in the form of input signals for the flight control device. The nominal commands 30a in the form of input signals for the flight control device 50 may be composed of a nominal acceleration and/or a nominal heading for the aircraft that depend on the flight data of the tanker aircraft. In this case, the flight data may include a position, speeds and accelerations. The flight control device 50 is configured in such a way that it generates a current input signal vector 50a for adjusting the actuator 21 and the flow influencing devices 15; 15K from the nominal commands and transmits the input signal vector to this actuator and these flow influencing devices.

When the refueling process is carried out, the flight control device 50 adapts, for example, the lift of the aircraft F to its mass that continuously increases during the refueling process, i.e., the parameters of the control carried out with the control device 50 which are influenced by the aircraft weight are modified in accordance with the changing weight of the aircraft to be refueled, i.e., adapted thereto. The flow influencing devices 15; 15K adjusted by the flight control device 50 with the current input signal vector 50a may be positioned on the main wing M and/or an adjusting flap K, wherein the respective flow influencing device 15; 15K of a surface segment is composed of at least one flow influencing device and at least one flow condition sensor. According to FIG. 2, one respective arrangement 15 and 15K of at least one respective flow influencing device 16 and 16K and at least one respective flow condition sensor 17 and 17K is positioned in a segment 10 on the upper side M-1 of the main wing and a segment 10K on the upper side K1 of the adjusting flap K. Corresponding segments 11a, 11b, 12a, 12b, in which such an arrangement 15 of at least one flow influencing device 16 and at least one flow condition sensor 17 is positioned, are schematically illustrated on the main wings of the airfoils in FIG. 1. Such a segment 10K with an arrangement 15K of at least one flow influencing device 16K and at least one flow condition sensor device 17K may alternatively or additionally be positioned on the upper side K1 or the underside K2 of the respective adjusting flap K as illustrated in FIG. 2.

The respective flow influencing device 15 or 15K is configured in such a way that it can influence the flow on the respective surface and therefore the coefficient of lift of the main wing M or the regulating flap K based on current control signals or based on a current control signal vector 50a. In this case, the flight control device 50 has a function that selects the flow influencing devices 15; 15K to be actuated depending on the flight attitude in order to optimize local coefficients of lift on the airfoil. The flight control device determines nominal local flow condition values segmentally in this case, i.e., the current control signal vector 50a contains control signals for each of the controllable segments 10, 10K.

In this case, the control signal vector 50a may be configured in such a way that it contains a value for all flow influencing devices 15; 15K that can be actuated, wherein the control value zero is assigned to the flow influencing devices 15; 15K that should not be actuated based on the selection and in accordance with the respective current control signal or control signal vector 50a.

The flight control device 50 may in this case be configured, in particular, in such a way that it generates a current control signal vector 50a for adjusting the actuator 21 of the at least one control flap S and the flow influencing devices 15; 15K by means of a controller model for the aircraft and transmits the control signal vector to this actuator and these flow influencing devices, wherein the flight control device 50 determines the current input signal vector 50a based on the nominal commands 30a of the specification device 30, the sensor signals 40a of the flight attitude sensor device 40 and the sensor signals of the flow condition sensor device 17; 17K.

The flight control device 50 may furthermore have a prioritizing function that mixes an actuation of the flow influencing devices 17; 17K and an actuation of control flaps S in dependence on the flight data of the tanker aircraft. A prioritization of flow influencing devices 17; 17K may be preferable in more dynamic scenarios.

The flight control device 50 may furthermore have an estimating function that is designed for estimating whether a flight within the instantaneous flight range limits of the aircraft is even possible in the predetermined corridor relative to the tanker aircraft with the instantaneous mass of the aircraft F, namely based on the transmitted flight data of the tanker aircraft. It may be assigned a warning signal function that, when approaching a flight range limit, generates a warning signal to be subsequently transmitted to the tanker aircraft via the flight data transmission device D.

In this case, the flight control device 50 may have an estimating function that is designed, in particular, for estimating whether a flight within predetermined deviations along the nominal flight path or within the nominal flight path corridor lies within the instantaneous flight range limits of the aircraft F with the instantaneous mass thereof, namely in dependence on deviations of the aircraft from the nominal flight path and/or in dependence on the positions of the aircraft in the nominal flight path corridor and/or depending on changes of these variables. The flight control device 50 may, in particular, furthermore have a warning signal function that generates a warning signal when approaching a flight range limit and/or at a predetermined distance from the nominal flight path and/or a predetermined distance from the nominal flight path corridor, wherein the flight control device 50 transmits said warning signal to the flight data transmission device D for transmission to the tanker aircraft F.

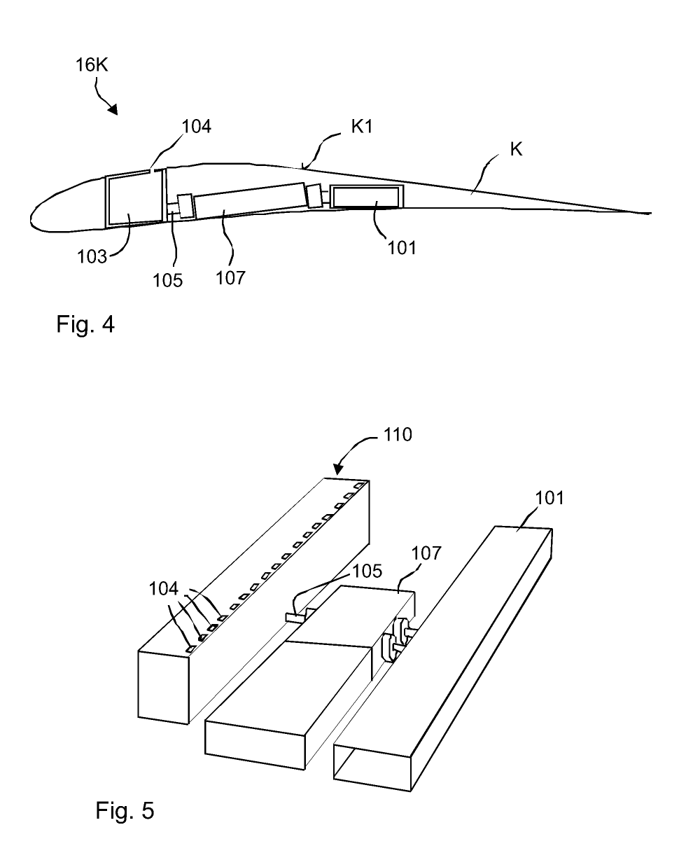

An example embodiment of the flow influencing device 16, 16K of a segment is illustrated in FIG. 4 using the example of a flow influencing device 16K of an adjusting flap K. In this case, the flow influencing device 16K is composed of a pressure chamber 101 for accommodating compressed air, an outlet chamber or blow-out chamber 103 and one or more connecting lines 105 for connecting the pressure chamber 101 to the outlet chamber 103. The blow-out chamber 103 includes at least one outlet opening or blow-out opening, preferably an arrangement 110 of outlet openings or blow-out openings. One individual blow-out opening 104 is illustrated in FIG. 5 purely for exemplification purposes. At least one valve unit 107 is integrated into the at least one connecting line 105 and functionally connected to the flight control device 50. The flight control device 50 activates the valve unit 107 by means of the current control signal vector 70a in order to prevent the compressed air situated in the pressure chamber 101 from flowing into the outlet chamber 103 or to enable this compressed air to flow into the outlet chamber with a corresponding speed and/or throughput in accordance with the nominal values of the current control signal vector 70a, wherein the air is discharged from the outlet chamber through an arrangement 110 of blow-out openings in order to influence the flow around the surface K1 of the adjusting flap K.

The introduction of compressed air into the pressure chamber 101 may be realized in different ways. In this case, it would be possible to withdraw the compressed air from the outside flow at a stagnation point area on the surface of an aerodynamic body of the aircraft, particularly a stagnation point area on the adjusting flap or a stagnation point area of the main wing. A pressure generating device or a pump or a flow variator that receives the air via a supply line may also be connected to the pressure chamber. The supply line may originate, in particular, at an opening or an arrangement of openings on the upper side of the main wing M and/or the flap K. In this case, the opening may be arranged at a location or the arrangement of openings may be distributed over an area of the main wing M and/or the flap K in such a way that suction effects occurring at these locations correlate with the blow-out effects generated by means of the arrangement 110 of blow-out openings in a predetermined fashion.

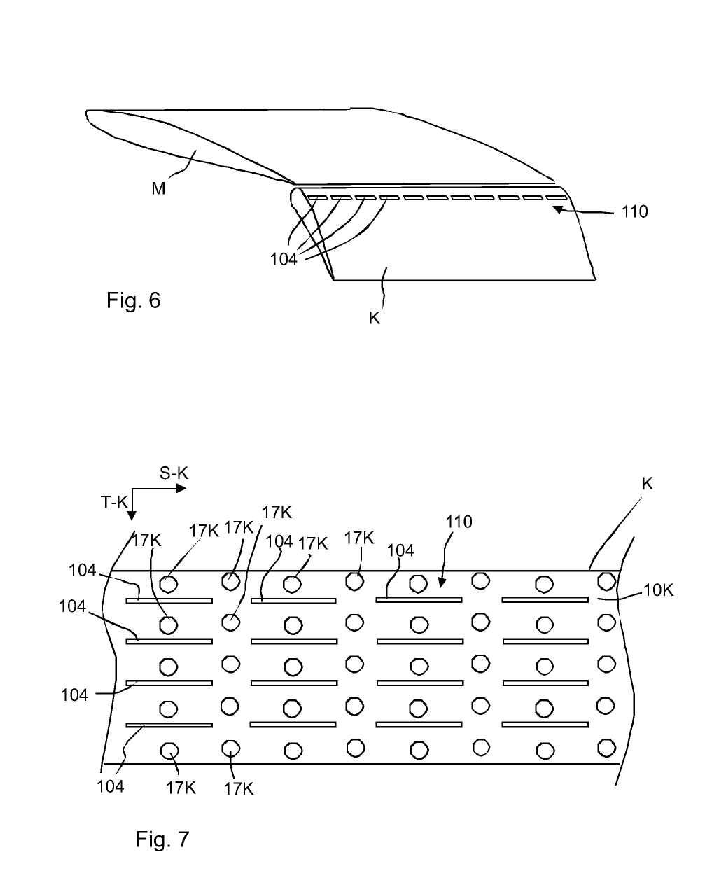

FIG. 5 schematically shows the flow influencing device 16K that is illustrated in the installed state in FIG. 4 in the form of a structurally isolated device. FIG. 6 schematically shows an airfoil with a main wing M and an adjusting flap K in the form of a high-lift flap that is coupled to the main wing, wherein an arrangement 110 of blow-out openings is positioned on the upper side of said adjusting flap.

The arrangement 110 of blow-out openings or the opening device is preferably composed, in particular, of an arrangement of slot-shaped openings (FIGS. 5 to 7). According to various embodiments of the invention, the blow-out openings that are fluidically connected to one or more blow-out chambers are preferably distributed over a surface segment of the aerodynamic body of the aircraft. In this case, several surface segments may be arranged adjacent to one another or behind one another referred to the flow direction S in order to influence the flow over a larger area of the aerodynamic body. The flight control device 50 determines the control commands, as well as control values corresponding thereto, for each arrangement 15, 15K of flow influencing devices 16 and 16K and flow condition sensor devices 17 and 17K of each controllable segment 10, 10K, i.e., of segments 10, 10K that include such arrangements 15, 15K of flow influencing devices 16 and 16K and flow condition sensor devices 17 and 17K and are distributed over the aerodynamic body, e.g., over the main wing, at least one adjusting flap and/or control flap.

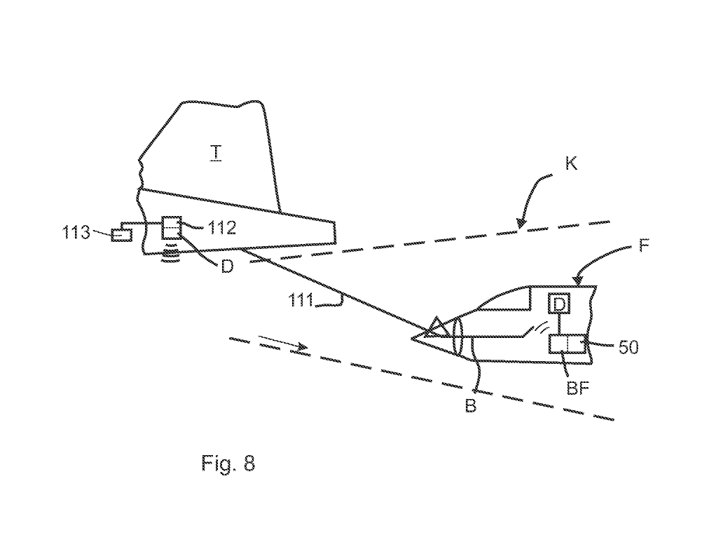

FIG. 8 shows an example top view of a surface segment 10K with an arrangement 15K of flow influencing devices and flow condition sensor devices that, according to various embodiments of the invention, may generally be positioned in a surface segment of the main wing or an adjusting flap and generally an aerodynamic body of the aircraft F. The arrangement illustrated in FIG. 7 includes an arrangement 110 of blow-out opening 104 that is distributed over the surface segment 10K in a matrix-like fashion. The blow-out openings 104 of the arrangement 110 of blow-out openings are generally distributed over the entire surface segment in order to influence the flow on or above the entire area of the surface segment 10 or 10K, respectively. A pressure chamber and a valve unit 107 are preferably assigned to the openings 104 of a surface segment 10, 10K. Alternatively, a pressure chamber 101 may also be assigned to the openings 104 of several surface segments 10, 10K.

The blow-out openings 104 have a shape that is optimized for influencing the flow around the respective surface segment 10, 10K. In this case, different shapes of blow-out openings 104 may be used within a surface segment 10, 10K. For example, the blow-out openings 104 may also be configured circular, ellipsoidal or lunulate.

A plurality of flow condition sensor devices 17 and 17K are also arranged within a surface segment and schematically illustrated in the form of circular symbols in FIG. 8. All flow condition sensor devices 17 and 17K are functionally connected to the flight control device 50 (FIG. 3) in order to transmit current flow conditions at the location of the respective flow condition sensor device 17 or 17K in the form of sensor signals that are respectively generated by each of the flow condition sensor devices 17 and 17K. Based on the measured flow conditions, the flight control device 50 determines the blow-out openings 104 of each segment to be activated, as well as the intensity, with which the air should be blown out, in order to adjust a flight attitude of the aircraft that corresponds to the nominal commands generated by the specification device 30 for generating flight attitudes of the aircraft. In this case, the flight control device 50 simultaneously determines nominal commands for the actuators of the control surfaces S.

Different surface segments may be arranged adjacent to one another or in an overlapping fashion on the surface of the aerodynamic body, e.g., the main wing and/or the adjusting flap K.

The flight control device 50 may also utilize flow conditions that are determined by means of flow condition sensor devices 17, 17K arranged in other surface segment 10, 10K for determining control commands for flow influencing devices 16, 16K.

Due to the corresponding function of the flight control device 50, it also adjusts, in particular, the degree, to which the flow on the respective surface segments 10, 10K can be influenced, by adjusting the flow influencing devices 16 and 16K of one or more surface segments 10, 10K. Corresponding values of the current control signals or the current control signal vector 50a are determined for this purpose. In this case, the flight control device 50 activates the valve unit or valve units 107 of several surface segments 10, 10K. A pulsed blow-out, in particular, may be realized in this case.

The flight control device 50 may alternatively or additionally activate an opening device on the respective blow-out openings 104 in order to adjust the air flow being blown out of the respective blow-out openings 104 by opening and closing said device.

In addition, the flight control device 50 may be functionally connected to a pressure generating device that is coupled to the pressure chamber or to a (not-shown) flow generating device that is coupled to the pressure chamber in order to adjust the pressure in the pressure chamber by correspondingly activating the pressure generating device or the flow generating device and to thusly adjust the blow-out speed at the openings 104 of a surface segment 10, 10K. In this case, the pressure in the pressure chamber may be adjusted based on the flight attitude and, in particular, based on the flying speeds and the altitude or variables derived thereof. The flight control device 50 may also deactivate the pressure generating device in certain flight attitudes such as, e.g., in the cruising mode. The pressure generating device may generally also have a permanently adjusted output or be configured in such a way that it varies or controls the inlet pressure and/or the blow-out pressure and/or the differential pressure based on a corresponding activation by an activating function.

In this case, the flow generating device may be installed or integrated into a channel connected to the opening.

The flow condition sensor devices 17, 17K may generally include sensors for detecting characteristics of the flow condition on the upper side of the main wing M or the flap K and be configured in such a way that the flow condition can be positively determined from the signal generated by the sensor, i.e., that it is possible to determine whether or not a separated flow is present.

According to various embodiments of the invention, an aircraft is proposed that includes a flight control device with an actuating device or control input device 31 that is connected to the flight control device and serves for generating nominal control commands 31 a for the control of the aircraft F. The control input device 31 of the aircraft F usually includes a control input device 31 for inputting control specifications and for thusly controlling the flight path of the aircraft, wherein this control input device is arranged in the cockpit of the aircraft and may include, in particular, pilot input means such as a joystick, as well as optional pedals.

The flight control device may furthermore include an operating mode input device and/or an autopilot 34 that respectively generates nominal autopilot commands 34a for controlling the aircraft F and is functionally connected to the flight control device 50 in order to transmit the respective nominal commands 31a and 34a to the flight control device.

According to an embodiment of the invention, the control input device 31 is switched into the inactive state in the refueling mode. This may be realized when the refueling mode is selected, for example, on an instrument panel or a pilot display.

In this embodiment, no inputs can be realized by means of the control input device 31 while the aircraft F is refueled such that no interventions in the automatic tracking control of the aircraft F take place. One of the described embodiments of the aircraft and, in particular, of the control device 50 and the thereby implementable method may be used in this case.

According to an alternative embodiment of the invention, the control input device 31 remains switched into the active state when a second refueling mode is activated due to the selection thereof, for example, on an instrument panel or a pilot display device. In this case, this second refueling mode may be activated in addition to the above-described first refueling mode due to the selection thereof, for example, on an instrument panel or a pilot display device or realized in the aircraft F as an alternative to the first refueling mode. In this second refueling mode, inputs can be realized by means of the control input device 31 while the aircraft F is refueled such that the pilot can intervene in the automatic tracking control of the aircraft F by actuating the control input device 31.

The first and/or the second refueling mode may be configured in such a way that the nominal flight path generated thereby and/or the nominal flight path corridor generated thereby and, in particular, its boundary lines or boundary surfaces are displayed on a pilot display together with the position of the aircraft relative to the nominal flight path or the nominal flight path corridor, respectively. In addition, the displayed nominal flight path corridor may also contain at least one reference line or orientation line that indicates the flight path, along which the aircraft should fly. The nominal flight path and the nominal flight path corridor respectively depend on the flight path and the position and the instantaneous flight attitude of the tanker aircraft such that the nominal flight path and the nominal flight path corridor respectively are repeatedly calculated anew within predetermined time intervals and displayed to the pilot in updated form in certain time intervals. It would also be possible to display this information in the form of a Flight Director, namely either by default or in response to a corresponding selection. In this case, the current position of the aircraft to be refueled relative to the tanker aircraft is schematically displayed from the view of the aircraft being refueled, in which the respective display device is installed. The nominal flight path or the nominal flight path corridor therefore is displayed in the form of a preferably perspective representation, in which the position of the observer lies in the aircraft to be refueled and, in particular, in the cockpit. Furthermore, each of the aforementioned illustrations may additionally contain one or more of the following:
illustrations such as graphical and/or numerical references to deviations from the nominal flight path and the distance of the aircraft from boundaries of the nominal flight path corridor or from its orientation line and/or
graphical references to changes of the actual flight path or changes of direction of the aircraft to be refueled that should be realized in accordance with the method.

In an embodiment of the second refueling mode, the actuation of the control flaps or part of the control flaps such as, in particular, a part of the spoilers may be carried out manually by the pilot, e.g., with the aid of a control lever, wherein the pilot carries out this actuation in view of one of the above-described display modes if such display modes are respectively realized in the aircraft. The pilot therefore carries out a rough control of the aircraft. In this embodiment of the second refueling mode, the more precise correction of the aircraft position relative to the nominal flight path or the nominal flight path corridor or a reference line or orientation line is realized by means of the control device 50 that generates nominal commands for the flow influencing devices based
on the measured flow condition,
on the nominal flight path or the nominal flight path corridor,
optionally on the actuating information and/or the adjusted position of the respectively actuated control flap S and
optionally on detected flight attitudes 40a.

In this way, a correcting movement of sorts of the aircraft F to be refueled is achieved during the refueling process if the aircraft is flown by the pilot rather than automatically.

The embodiments and pilot displays described herein may alternatively or additionally be used during the initiation of the refueling process, i.e., particularly when flying or controlling the aircraft to be refueled into its refueling position relative to the tanker aircraft.

In the embodiments of pilot displays described herein, the actuation of the flow influencing devices and/or the proportion of the control movement realized by means of the flow influencing devices can, in particular, also be graphically displayed in relation to the control movement realized due to the adjustment of control flaps S.

According to another embodiment, the control input device 31 may include input means for the pilot in order to separately adjust or actuate the flow influencing devices 16, 16K. In this case, a suggestion for the actuation of the flow influencing devices or for a nominal actuation of the flow influencing devices may, in particular, also be graphically displayed on the embodiments of pilot displays described herein.

The above-described reference line or center line of a nominal flight path corridor basically can be obtained geometrically by connecting the centers of cross-sectional areas of the nominal flight path corridor.

At least one actuator and/or one drive is assigned to the respective control flaps provided on the aircraft F such as, e.g., the ailerons 5a, 5b or the spoilers 2a and 2b, wherein the respective actuators and/or drives optionally are, according to various embodiments of the invention, activated by the flight control device 50 with command signals that represent nominal commands in order to adjust the respectively assigned control flaps and to thusly control the aircraft F. In this case, a control flap of this type may be respectively actuated by one actuator for a plurality of actuators in order to improve the reliability of the aircraft system.

Nominal commands for actuating or moving actuators of the control flaps S, 2a, 2b, 5a, 5b and, in particular, the actuator for adjusting the flow influencing devices 16, 16K and/or the actuator or the flap drive of the adjusting flap K to be activated are generated in the flight control device 50 based on the nominal control commands 31 a of the control input device 31 and/or the nominal autopilot commands 34a of the autopilot 34 and transmitted to these actuators. The actuator for adjusting the flow influencing devices 16, 16K may, in particular, include the assigned valve unit and/or the respectively assigned pressure generating device or flow generating device.

The aircraft F furthermore includes a flight attitude sensor device 40 that is functionally connected to the flight control device 50 and includes an air data sensor device 41 (Air Data System, ADS) for detecting flight attitude data and thusly determining the flight attitude, as well as an attitude sensor device or an inertial sensor device 42 (Inertial Measurement Unit, IMU) for detecting a flight attitude of the aircraft F and, in particular, turning rates of the aircraft F. The air data sensor device 41 includes air data sensors for determining the flight attitude of the aircraft F and, in particular, the dynamic pressure, the static pressure and the temperature of the air flowing around the aircraft F. The attitude sensor device 42 determines, in particular, turning rates of the aircraft F including the rates of yaw and the rates of roll of the aircraft in order to determine the attitude thereof. The flight control device 50 receives the flight attitude sensor signals 40a of the sensor values acquired by the flight attitude sensor device 40 and, in particular, the air data sensor signals 41 a of the air data sensor device 41, as well as the attitude sensor data 42a of the attitude sensor device 42.

The flight control device 50 in the form of a flight attitude control device 70 (FIG. 3) has a control function that receives control commands from the control input device 30 and sensor values 40a from the sensor device 40. The control function is configured in such a way that it generates control commands for the actuators in dependence on the control commands 30a and the acquired and received sensor values 40a and transmits the control commands to these actuators such that the aircraft F is controlled in accordance with the control commands due to the actuation of the actuators. As mentioned above, FIG. 3 shows an embodiment of the invention, in which respective arrangements 15 and 15K of respective flow influencing devices 16 and 16K and respective flow condition sensors 17 and 17K are positioned on the main wing M and the regulating flap K at a certain location in the respective wing spread direction.

While flying, the pilot generates a nominal command 31 a for the control of the aircraft by means of an actuating device 31. The nominal command 31a for the aircraft control may include, e.g., a three-dimensional acceleration vector for realizing a relative change of the flight attitude of the aircraft or for specifying a change of direction. The nominal command vector may also be composed of both specification values and generate change of direction specifications for the lateral movement and acceleration specifications for the vertical movement of the aircraft. In addition, nominal commands or nominal command vectors 34a may also be generated by means of an autopilot 34.

According to various embodiments of the invention, the flow influencing specification device 30 activates the flight control device 50 as shown in FIG. 3, wherein the flight control device subsequently generates control commands 50a, preferably in the form of a control signal vector 50a, based on sensor values and activates at least one actuator of this type that is arranged in a segment 10 or 10K on a surface of the airfoil and optionally the at least one adjusting flap K that can be actuated by said actuator, as well as an actuator 21 of the control flaps S. Consequently, the flight control device 50 generates respective flow condition control commands 351 and 351K for actuating or moving at least one actuator or drive of the respective flow influencing devices 15 and 15K of each concerned segment 10 and 10K in order to adjust the flow influencing devices, as well as control commands 352 for actuating or moving at least one actuator or flap drive 21 of the control flaps 21 to be activated, based on nominal commands 30a of the specification device 30 and transmits the control commands to these actuators or drives.

The flight control device 50 may also generate (not-shown) control commands for adjusting the adjusting flap K based on corresponding inputs on the specification device 31 and nominal commands 31 a generated thereof and transmit these control commands to an actuator in order to realize the adjustment thereof. The flight control device 50 may also generate such control commands for adjusting the adjusting flap K based on flight attitude data. In this case, the respective flow condition control commands 351 and 351K may also be determined in dependence on the control commands for adjusting the adjusting flap K, as well as in dependence on the control commands 352 for adjusting the control flap S. Alternatively, the respective current control signal vector 50a generated by the flight control device 50 may contain the control commands for adjusting the actuator 21 of the at least one control flap S, the flow influencing devices 16; 16K and optionally the adjusting flaps K, as well as information on the flow influencing devices that should be actuated at a given time.

Due to the actuation or movement of the actuators of the flow influencing devices, the local coefficients of lift or the ratios between coefficient of drag and coefficient of lift are changed in a predetermined fashion in the wing spread area, in which the segment 10 or 10K with the respectively activated flow influencing devices is positioned. If several segments 10, 10K are arranged in the wing spread direction and/or in the chord direction of the main wing or the flap K, the respective flow condition control commands 351 and 351K for the flow influencing devices of the respective segments may be adapted and consolidated by means of a segment activating function or respectively determined by a superordinate control command.

In the instance, e.g., in which each airfoil 1a, 1b includes two segments 10 that are respectively provided with an arrangement 15 and 15K of flow influencing devices 16 and 16K and flow condition sensors 22 and 22K, as well as two regulating flaps K for stabilizing and/or controlling the aircraft and/or adjusting a flying mode in a functionally predetermined fashion, the flow influencing specification device 30 and therefore the flight control device 50 activates the aforementioned flow influencing devices and the flap drives of the control flaps in dependence on the time in order to realize their adjustment, namely based on control algorithms implemented in the flight control device, wherein a flight attitude that corresponds to the nominal commands 31a and/or 32a for the control of the aircraft F or a flying mode is adjusted in order to thusly stabilize the aircraft in an attitude and/or to carry out a flight path control movement and/or to adjust the load distribution of the airfoil and/or to compensate gusts.

The airfoil used may also be configured in such a way that it does not include a regulating flap that is functionally connected to the flow influencing specification device 30 or the flight control device 50 in order to control or stabilize the aircraft. In this case, the flow influencing specification device 30 or the flight control device 50 activates flow influencing devices 16 of at least one airfoil segment 10. According to various embodiments of the invention, an arrangement 15K of flow influencing devices 16K and flow control sensors 17 may be analogously provided segmentally on the surface of at least one regulating flap and functionally connected to the flow influencing specification device 30 or the flight control device 50 in the above-described fashion in order to control or stabilize the aircraft.

The control device therefore generally includes a flow influencing specification device 30 with an activating function for generating nominal commands for drives in order to adjust flow influencing devices 16 and 16K of the at least one surface segment 10 or 10K and/or nominal commands for drives in order to adjust at least one regulating flap per airfoil, wherein the control device determines corresponding nominal commands for actuating adjusting devices on the wings based on the nominal commands for controlling the aircraft, and wherein the flight attitude of the aircraft is changed or influenced in accordance with the nominal commands due to the activation of said adjusting devices.

In this case, an input value derived from the nominal command 30a of the flow influencing specification device 30 may be fed to the flow influencing device 16, 16K as input value, wherein said input value is determined
by means of a flight control device 50 that is based on flight attitude sensor data, as well as flow condition sensor data, or
from the nominal command 30a (reference symbol 66 in the example embodiment according to FIG. 3) by means of a flight attitude control device 70 that is based on flight attitude sensor data.

The activation and actuation of the at least one actuator of the flow influencing devices 16 or 16K of one respective segment 10 or 10K may take place, in particular, based on nominal commands 30a of a flow influencing specification device, wherein said nominal commands are transmitted to a flow condition control device that respectively generates a flow condition control variable for the actuator of the flow influencing devices 16 are 16K of a wing from the nominal commands 30a for each respective segment 10 and 10K of the at least one segment 10 or 10K, and wherein said flow condition control variable corresponds to a required local coefficient of lift for the area of the respective segment at a given time. Due to the activation and adjustment of the actuator of each respective segment by means of the flow condition control variable, the respective actuator is activated such that the respectively assigned flow influencing device 16 or 16K influences the flow condition on the local segment of the airfoil and therefore influences and changes, in particular, the flow condition on the respective segment 10 or 10K.

In the example embodiment illustrated in FIG. 3, the flight control device 50 is connected to a flight attitude sensor device 40 in order to receive flight attitude sensor signals 40a.

In this case, the flight control device 50, particularly in the example embodiment according to FIG. 3, may include a control algorithm that adjusts the aforementioned input values in accordance with the received nominal commands 30a (“complete control”).

The control algorithm of the flight control device 50 and/or the flow condition control device 60 may on the one hand carry out a synthesis of a respective quantity for the lift, the drag or the lift/drag ratio obtained from sensor data (particularly a sensor device 17 in the form of pressure sensors on the airfoil or on the flap K), and on the other hand include a robust control algorithm for reaching a specified target value for the aforementioned quantity. The controller is supported by an Anti-Wind-Up-Reset-Structure. The quantity is obtained from a combination of time integration and look-up table and can be bijectively linked with a flight-relevant variable such as, e.g., the lift. In this way, an indirect specification, e.g., of a lift or a coefficient of lift that is subsequently converted into a specification of the quantity by means of an algorithm can be realized. This specification of the quantity is referred to as nominal value below and used for determining the deviation from the current quantity that then defines the intensity and the type of the controller intervention.

The controller may be designed on the basis of a linear Multivariable-Black-Box-Model with a method for the synthesis of robust controllers. During the identification of the linear Multivariable-Black-Box-Model, suitable interference signals in the form of erratic changes of the actuation variable are generated and the reaction of the quantity to these changes is measured. A linear differential equation system that represents the basis for the controller synthesis is obtained from the dynamic behavior of the reaction with the aid of parameter identification methods. Many different identifications of this type deliver a model family, from which a representative or average model is selected per synthesis. Certain methods can be used in the controller synthesis (e.g., Hoc-Synthesis, robustification, robust LoopShaping). The created classic linear control loop can be supported by an Anti-Wind-Up-Reset-Structure that, if a correcting variable that lies above the realizable correcting variable is requested, corrects the internal conditions of the controller in such a way that an integration section in the controller does not lead to overshooting or freezing of the controller. In this way, the controller also remains responsive when it receives unrealistic requests such that the operational reliability is increased. It is always adapted to the current situation and not delayed by preceding correcting variable limits.

The controller may be configured, in particular, in the form of an optimal controller that receives all required input variables in the form of controlled variables and generates the different output signals for the flow influencing device 16 or 16K and/or the actuator 21 or flap drive of the at least one activated regulating flap K in accordance with a control algorithm in a matrix-like method—based on calibrations and parameters for the assignment of controlled variables and correcting variables derived thereof in dependence on flight attitude variables.

According to various embodiments of the invention, a flight-relevant parameter (lift, coefficient of lift, drag, lift/drag ratio, etc.) is determined in an instationary fashion from substitute controlled variables in order to subsequently use this parameter for a nominal value comparison and to ultimately adjust and reach a basically arbitrary value for the respective parameter—within the scope of physics—by means of linear, robust control algorithms designed for a linear model.

Since no heavy moving parts are used, the control system is significantly faster than conventional mechanical solutions such that local flow phenomena can be purposefully suppressed or utilized, respectively.

FIG. 8 ultimately shows a refueling system with a tanker aircraft T featuring a fuel delivery device 111 and an aircraft F being refueled. The tanker aircraft includes a control unit 112 that is designed for transmitting flight data of the tanker aircraft T to the aircraft F being refueled via the data link D. For this purpose, the control unit 111 may be connected to a flight management system, a flight control device or other devices of the tanker aircraft T that are familiar with the instantaneous flight data. The flight control device 50 of the aircraft F being refueled preferably is designed for transmitting the instantaneous flight data to the tanker aircraft T via the flight data transmission device D. Consequently, the control unit 111 of the tanker aircraft T is able to compare the instantaneous flight path of the aircraft F being refueled with the corridor K defined by the tanker aircraft T and to generate a warning signal if the aircraft F being refueled leaves the corridor K, wherein said warning signal alerts, for example, a pilot of the tanker aircraft T of a possible problem.

The tanker aircraft T preferably also includes a control intervention device 113 that is functionally connected to the control unit 111 and designed for initiating an adaptation of flight parameters of the tanker aircraft T when a warning signal is received, for example, for increasing the flying speed of the tanker aircraft T as the weight of the aircraft F being refueled increases.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An aircraft with a refueling device for receiving fuel from a tanker aircraft in-flight and with airfoils that comprise a main wing and at least one control flap that is arranged such that it can be adjusted relative to the main wing, wherein the aircraft comprises:
a flight attitude sensor device that detects flight attitudes of the aircraft,
an actuator that actuates the at least one control flap,
at least one arrangement of flow influencing devices that are arranged in at least one surface segment of the main wing extending in the wing spread direction and that influence the air flow on the surface segment, and
at least one arrangement of flow condition sensor devices that measure the flow condition on the respective surface segment,
a flight data transmission device that is designed for receiving flight data, particularly of a tanker aircraft,
a flight path specification module that is functionally connected to the flight data transmission device and determines a nominal flight path or a nominal flight path corridor from the flight data of the flight data transmission device, and
a flight control device that is functionally connected to the flight attitude sensor device and the flight path specification module on the input side and functionally connected to the actuator and the flow influencing devices on the output side in order to transmit control commands,
wherein the flight control device is configured in such a way that it generates nominal commands for the flow influencing devices based on the position of the aircraft relative to the nominal flight path or relative to the nominal flight path corridor and transmits these nominal commands to the flow influencing devices, wherein these nominal commands control or maintain the movement of the aircraft along the nominal flight path or in the nominal flight path corridor.

2. The aircraft of claim 1, wherein the aircraft comprises:
a specification device that is connected to the flight data transmission device on its input side and generates nominal commands corresponding to flight attitudes of the aircraft in the form of input signals for the flight control device, and
a flap position sensor device for detecting the adjusted position of the control flap,
wherein the flight control device is also functionally connected to the specification device and the flap position sensor device on its input side, wherein the flight control device has a function that generates nominal commands for the actuator for actuating the at least one control flap and for the flow influencing devices based on the nominal commands of the specification device, the measured flow condition and the nominal flight path or the nominal flight path corridor and transmits these nominal commands to said actuator and said flow influencing devices such that the movement of the aircraft is controlled or maintained along the nominal flight path or in the nominal flight path corridor within predetermined deviations.

3. The aircraft of claim 1, wherein the flight control device selects the flow influencing devices to be actuated in dependence on the respectively detected flight attitude and/or the measured flow condition and/or the received nominal commands in order to optimize local coefficients of lift on the airfoil.

4. The aircraft of claim 2, wherein flight control device has a prioritizing function that mixes an actuation of flow influencing devices and an actuation of regulating flaps in dependence on deviations of the aircraft from the nominal flight path or positions of the aircraft in the nominal flight path corridor.

5. The aircraft of claim 1, wherein the flight control device generates commands for actuating the flow influencing devices based on a change of the deviation of the position of the aircraft from the nominal flight path or a change of the positions of the aircraft within the nominal flight path corridor such that the actuation of the flow influencing devices can be preferred in comparison with the actuation of the regulating flaps, particularly at a greater dynamic of the required lift.

6. The aircraft of claim 1, wherein the flight control device has an estimating function that estimates whether a flight within predetermined deviations along the nominal flight path or within the nominal flight path corridor lies within the instantaneous flight range limits of the aircraft with the instantaneous mass thereof, namely in dependence on deviations of the aircraft from the nominal flight path and/or in dependence on positions of the aircraft in the nominal flight path corridor and/or depending on changes of these variables.

7. The aircraft of claim 6, wherein the flight control device has a warning signal function that generates a warning signal when approaching a flight range limit and/or at a predetermined distance from the nominal flight path and/or a predetermined distance from the nominal flight path corridor, wherein the flight control device transmits said warning signal to the flight data transmission device for transmission to the tanker aircraft.

8. A method for controlling the flight path of an aircraft during the refueling thereof by means of a refueling device that receives fuel from a tanker aircraft in-flight, wherein said method comprises:
detecting flight attitudes of the aircraft,
receiving flight data of the tanker aircraft via a flight data transmission device,
determining a nominal flight path or a nominal flight path corridor from the flight data of the flight data transmission device,
measuring the flow condition on at least one surface segment of a main wing and
generating nominal commands for flow influencing devices of the main wing and/or the high-lift flap based on the measured flow condition and the nominal flight path or the nominal flight path corridor and transmitting the nominal commands to these flow influencing devices, wherein the nominal commands are defined in such a way that they control or maintain the movement of the aircraft along the nominal flight path or in the nominal flight path corridor.

9. The method of claim 8, wherein the activation of a refueling mode causes the control input device to be switched into an inactive state.

10. The method of claim 8, wherein the activation of a refueling mode causes the control input device to be switched into an active state such that an input by means of the control input device is possible during refueling of the aircraft and the actuation of the control input device by the pilot causes nominal commands for the actuator for actuating the at least one control flap to be generated in order to control or maintain the movement of the aircraft along the nominal flight path or in the nominal flight path corridor within predetermined deviations, and wherein the flight control device has a function that at least partially compensates deviations of the aircraft from the nominal flight path or approaches of boundaries of the nominal flight path corridor by actuating the flow influencing devices.

11. The method of claim 8, wherein flight data of the tanker aircraft is transmitted from the tanker aircraft to the aircraft being refueled and the flight data of the tanker aircraft is functionally taken into account in the determination of the nominal flight path or the nominal flight path corridor in order to in turn take into account the current nominal flight path or the current nominal flight path corridor in the movements of the tanker aircraft relative to the aircraft being refueled.

12. The method of claim 8, wherein the generated nominal flight path and/or the nominal flight path corridor generated thereby and its boundary lines or boundary surfaces are displayed on a pilot display together with the position of the aircraft relative to the nominal flight path or the nominal flight path corridor, respectively.

13. The method of claim 8, wherein the nominal flight path or the nominal flight path corridor is repeatedly calculated anew within predetermined time intervals depending on the flight path and the position and the instantaneous flight attitude of the tanker aircraft and displayed to the pilot in updated form within certain time intervals, wherein the display device displays a Flight Director and the current position of the aircraft to be refueled relative to the tanker aircraft from the view of the aircraft to be refueled.

14. A computer program product that causes a method claim 8 to be carried out on a program-controlled device.
